(19) United States
(12) Patent Application Publication
(10) Pub. No.: US 2006/0018063 A1
(43) Pub. Date: Jan. 26, 2006

(54) Method and circuit arrangement for esd protection of a connection terminal

(75) Inventors: Hendrik Boezen, Nijmegen (NL); Maarten Jacobus Swanenberg, Nijmegen (NL); Johnnes Van Zwol, Nijmegen (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: KONINKLIJKE PHILIPS ELECTRONICS N.V., Eindhoven (NL)

(21) Appl. No.: 10/536,272

(22) PCT Filed: Nov. 12, 2003
(86) PCT No.: PCT/IB03/05139

§ 371 Date: May 24, 2005

(30) Foreign Application Priority Data
Nov. 25, 2002 (EP) 02079887.2

(51) Int. Cl. H02H 9/00

(52) U.S. Cl. 361/56

(57) ABSTRACT

The present invention relates to a method and a circuit arrangement for protecting a connection terminal (CANH, CANL) of a semiconductor device against electrostatic discharge (ESD), wherein first and second common nodes (N1, N2) protected against ESD of respective first and second polarities are provided. Connection terminals are coupled via first diode means (D5, D6) to the first common node and via second diode means (D7, D8) to the second common node. Thus, several terminals or pins can share the same ESD protection device by connecting them to the first and second common nodes. Due to the fact that a diode requires a smaller chip area than a protection diode, the total chip area can be reduced.

The present invention relates to a method and a circuit arrangement for protecting a connection terminal, e.g. an input pad or bus pin of a semiconductor device, against electrostatic discharge (ESD).

As very large scale integration (VLSI) circuit geometries continued to shrink, the decrease in the corresponding gate oxide thicknesses, relative to the breakdown voltage, resulted in a greater susceptibility of the device to damage caused by the application of excessive voltages, for example, by an electrostatic discharge (ESD) event. In particular, during an ESD event, charge is transferred between one or more pins of the integrated circuit and another conducting object in a time period that is typically less than one microsecond. As indicated above, this charge transfer can generate voltages that are large enough to break down insulating films, e.g. gate oxides, on the device or can dissipate sufficient energy to cause electro-thermal failures in the device. Such failures include contact spiking, silicon melting, or metal interconnect melting.

Controller Area Network (CAN) is a serial bus system especially suited to interconnect smart devices to build smart systems or subsystems. CAN is based on the so-called broadcast communication mechanism achieved by using a message oriented transmission protocol. Thereby, data needed as information by several stations can be transmitted via the network in such a way that it is unnecessary for each station to know who is the producer of the data Thus, networks that one easy to service and to upgrade become possible, as data transmission is not based on the availability of specific types of stations. A CAN transceiver connects bus wires to an electronic control unit. In particular, a CAN transmitter consists of two drivers CANH and CANL which drive a differential signal on the bus. The polarity of the CANL signal is inverted with respect to the CANH signal, so the electromagnetic emission of the two wires cancel each other.

CAN is a communication network which may be used in cars. A special requirement for bus drivers is that the voltage on the bus pins can have very high positive values during a short circuit to the car battery and very high negative voltages when the ground connection to the module that contains the transceiver is interrupted. It is not allowed that any current flows to or from the bus connection pins CANH and CANL during such a fault in order to prevent disturbance of the communication between the other nodes. Also, no DC (direct current) shift should occur during applying of large high frequency (HF) signals on the bus pins. In a CAN transceiver, other pins to which high voltages are applied may be provided. Thus, ESD protection is of vital importance in CAN systems.

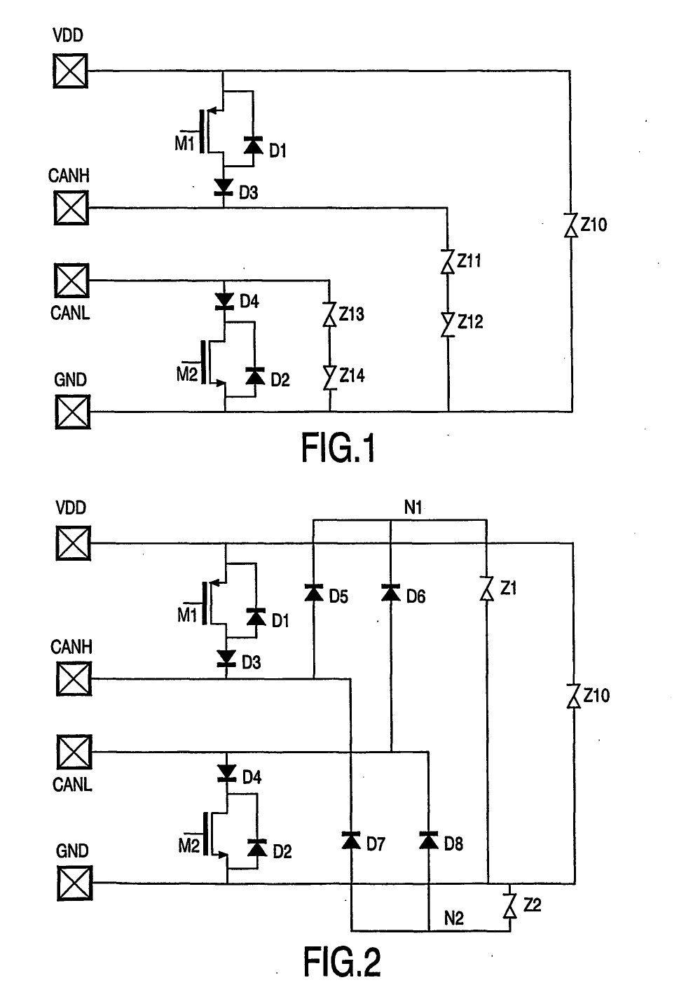

FIG. 1 shows a known bus driver output stage with ESD protection. Such a circuit is used in a CAN transceiver which drives the two bus wires CANH and CANL with symmetrical signals. The CANH driver consists of a P-channel device M1 and a series diode D3. The CANL driver consists of an N-channel device M2 and a series diode D4. The diodes D3 and D4 are needed to prevent current from flowing through the body diodes D1 and D2 of M1 and M2 when high voltages are present on the bus wires CANH and CANL.

According to FIG. 1, Zener diodes Z11 to Z14 are provided as ESD protection diodes. The other Zener diode Z10 is arranged to stabilize the positive operation voltage VDD.

The ESD protection Diodes Z13, Z14 and Z11, Z12 are connected in anti series. This is necessary to allow also negative voltages on the bus pins CANH and CANL. To achieve higher clamping voltages, for example needed for cars with 42 Volt battery systems, more ESD devices are usually connected in series to achieve the desired clamping voltage. Thus, each of the protection devices Z11 to Z14 might consist of one or more low voltage devices connected in series. Hence, a large chip area is required for ESD protection of each input terminal or bus pin.

Document U.S. Pat. No. 6,144,542 discloses a whole-chip ESD protection scheme with ESD busses for protection of integrated circuits with a large number of separated power lines. Bi-directional ESD-connection cells are connected between the separated power lines and the ESD busses but not between the separated power lines. Therefore, ESD current can be conducted away from the internal circuits by the ESD busses and quickly grounded through the bi-directional ESD protection devices. In this protection arrangement, one bi-directional protection device is required for each pin to the ESD bus and another one is required between the ESD bus and ground. This high number of bi-directional ESD protection circuits again leads to the problem of a large total chip area, which may be undesirable for certain applications, such as Controller Area Network (CAN) applications.

It is therefore an object of the present invention to provide an ESD protection structure which requires less chip area than the above conventional solutions.

This object is achieved by a method and a circuit arrangement as claimed in claims 1 and 10, respectively.

Accordingly, respective common nodes are provided for protection against ESD of each polarity. Any connection terminal or bus pin can thus be protected simply by providing a diode connection to the respective common node. The diode connection prevents current flow from one terminal to another. Due to the fact that a diode is much smaller in chip area than an ESD protection diode or device, the total chip area can be reduced significantly, especially when a plurality of terminals or bus pins have to be protected.

The first and second common nodes may be protected by respective first and second ESD protection means, or alternatively by a common ESD protection means. In the latter case, routing diodes may be provided for routing respective ESD charges of the first and second diode means through the common ESD protection means. In general, the ESD protection means may comprise a Zener diode.

Other connection terminals may be connected via respective third and fourth diode means to said first and second common nodes. Thus, each new connection terminal requires only two further diodes to achieve ESD protection. If the other connection terminal is connected to a respective internal connection of the first and second ESD protection means, the other connection terminal can be protected to a lower voltage. This may be achieved by providing first and second ESD protection means comprising a series connection of Zener diodes, wherein the internal connection is arranged between two of the Zener diodes of the series connection.

The first and second diode means and the ESD protection means may be monolithically integrated on the semiconductor device.

In the following, the present invention will be described in greater detail on the basis of preferred embodiments with reference to the accompanying drawings, in which:

FIG. 1 shows a conventional ESD protection circuit arrangement for a CAN transceiver;

FIG. 2 shows an ESD protection circuit arrangement according to a first preferred embodiment of the present invention, with two common ESD protection devices;

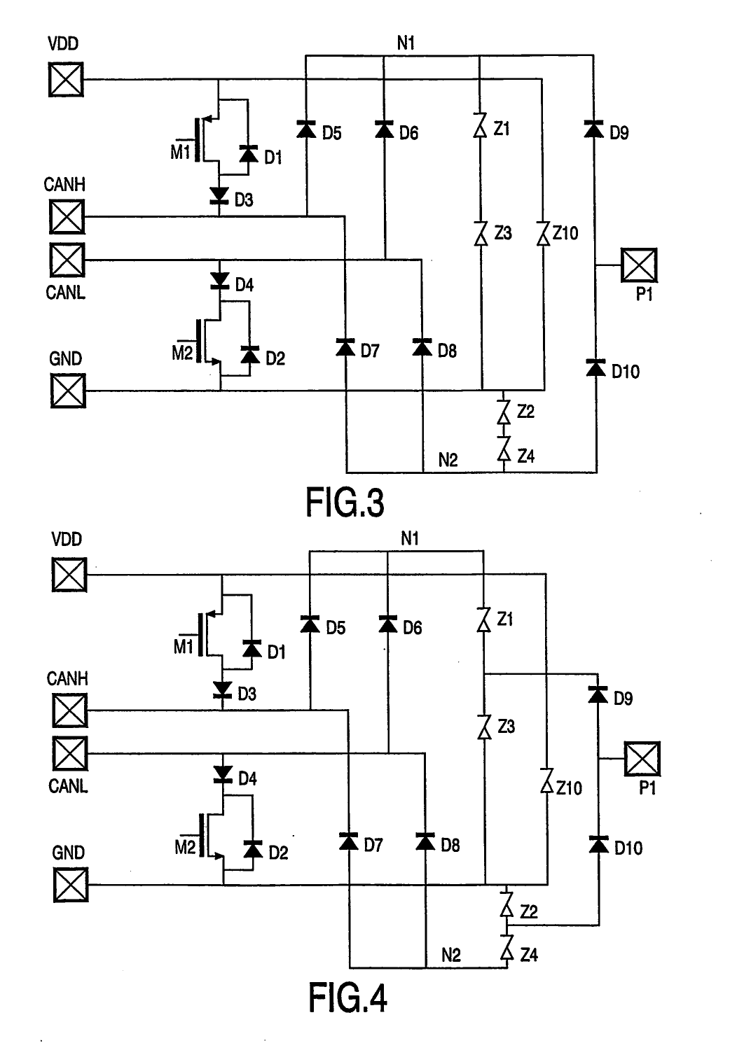

FIG. 3 shows an ESD protection circuit arrangement according to a second preferred embodiment of the present invention, which protects also other pins;

FIG. 4 shows an ESD protection circuit arrangement according to a third preferred embodiment of the present invention, with different protection voltages;

FIG. 5 shows an ESD protection circuit arrangement according to a fourth preferred embodiment of the present invention, with a single ESD protection device; and

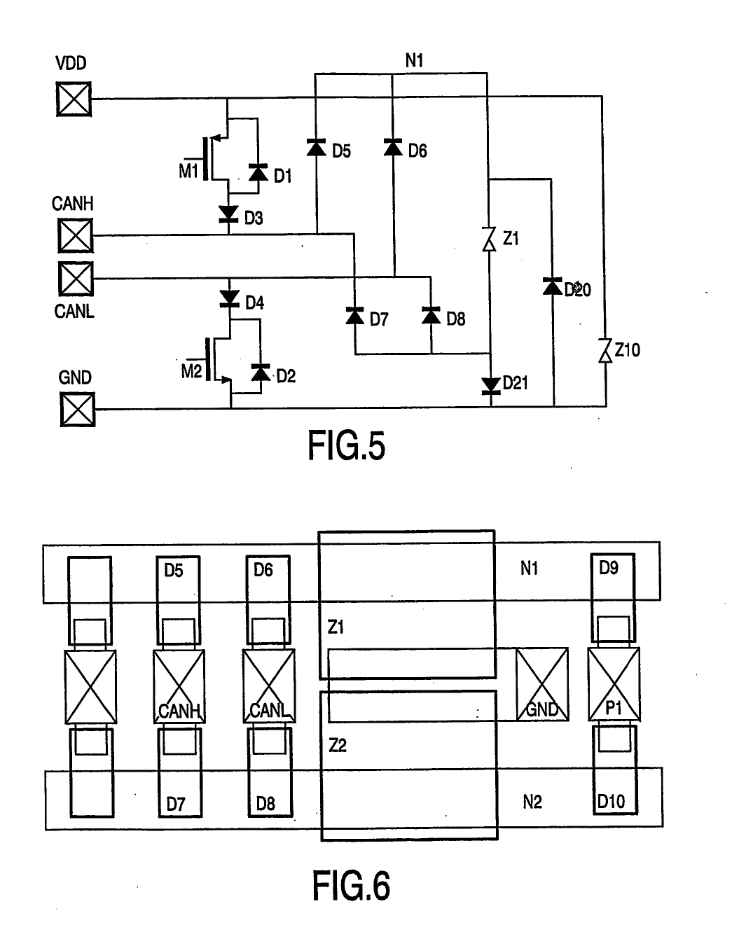

FIG. 6 shows a schematic diagram of a layout structure according to the present invention.

The preferred embodiments will now be described on the basis of an integrated semiconductor circuit arrangement of a CAN transceiver.

FIG. 2 shows an ESD protection circuit arrangement according to the first preferred embodiment of the present invention, in which two common ESD protection devices are used.

According to FIG. 2, two common nodes Ni and N2 are provided, which are ESD protected by respective Zener diodes Z1 and Z2. Each of the bus pins or terminals CANH and CANL is connected via respective first diodes D5 and D6 to the fist common node N1 and via respective second diodes D7 and D8 to the second common node N2. The polarity of the Zener diodes Z1 and Z2 and the first and second diodes D5 to D8 is selected so that positive ESD pulses are coupled to the first common node N1 and discharged to ground via the first Zener diode Z1, while negative ESD pulses are coupled via the second diodes D7 and D8 to the second common node N2 and discharged via the second Zener diode Z2 to ground.

Thus, the first Zener diode Z1 is the common ESD protection device for positive ESD pulses or voltages, and the second Zener diode Z2 is a common ESD protection device for negative ESD pulses or voltages. At positive ESD pulses on the bus pins CANH or CANL, the first diodes D5 or D6, respectively, are forward biased and the ESD voltage is limited to the clamping voltage of the first Zener diode Z1. At negative ESD pulses on the bus pins CANH or CANL, the second diodes D7 or D8, respectively, are forward biased and thus conducting, and the second Zener diode Z2 limits or clamps the negative voltages to the clamping voltage of the second Zener diode Z2.

Hence, only two ESD protection diodes are required for protecting the bus pins CANH and CANL.

FIG. 3 shows an ESD protection circuit arrangement according to the second preferred embodiment, wherein an additional terminal or pin P1 is ESD protected. This is achieved simply by connecting the other pin P1 via respective diodes D9 and D10 to the common nodes N1 and N2. The polarity of the new diodes D9 and D10 is selected in such a manner that positive ESD pulses are supplied to the first common node N1 and negative ESD pulses are supplied to the second common node N2. If the other pin P1 does not have to withstand negative voltages, D10 could be connected to the ground terminal GND instead of the second common node N2.

In the present second preferred embodiment, the ESD protection devices are shown as a series connection of respective Zener diodes Z1, Z3 and Z2, Z4. Thereby, higher protection or clamping voltages can be obtained based on a suitable selection of the respective clamping voltages.

FIG. 4 shows an ESD protection circuit arrangement according to the third preferred embodiment, wherein the other pin P1 is protected to a less positive voltage and a less negative voltage than the bus pins CANH and CANL, respectively. This is achieved by connecting the new diodes D9 and D10 to an internal connection of the series connected protection Zener diodes Z1, Z3 and Z2, Z4. Now, only the respective Zener diodes Z2 or Z3 limit the ESD voltage at the other pin P1 during an ESD event, resulting in a lower clamping or limiting voltage. Again, only additional diodes are needed to enhance the ESD protection capability.

FIG. 5 shows an ESD protection circuit arrangement according to the fourth preferred embodiment, in which positive and negative ESD events can be handled by a single protection device, i.e. Zener diode Z1. In particular, additional coupling or routing diodes D20, D21 and D22 are provided for routing respective positive and negative ESD pulses or currents through the same ESD protection Zener diode Z1. At positive ESD pulses on the bus pins CANH or CANL, the first diodes D5 and D6, respectively, and the routing diode D21 are forward biased and the Zener diode Z1 limits the voltage to its clamping voltage. At negative ESD pulses on the bus pins CANH or CANL, the second diodes D7 and D8, respectively, and the routing diode D20 are forward biased, and the ESD protection Zener diode Z1 again limits the voltage to its clamping voltage. At positive ESD pulses between the positive operation voltage VDD and the bus pins CANH or CANL, the routing diode D22 and the second diodes D7 and D8, respectively, are forward biased and the ESD protection Zener diode Z1 again limits the voltage to its clamping voltage. It is noted that here two diodes are connected in series during an ESD event, which causes a higher voltage at the bus pins CANH and CANL during ESD.

Also in the present fourth preferred embodiment, additional terminals or pins to be protected can be connected via respective additional diodes to the first and second common nodes N1 and N2.

FIG. 6 shows a layout of a monolithic integration of the first and second diodes D5 to D8, the additional diodes D9 and D10 for the other pin P1, and the ESD protection Zener diodes Z1 and Z2. Thus, this layout basically corresponds to the circuit arrangement of the second preferred embodiment as shown in FIG. 3, except that the series connections of Zener diodes Z1, Z3 and Z2, Z4 are replaced by respective single Zener diodes Z1 and Z2.

As can be gathered from FIG. 6, a compact circuit layout with reduced chip area can be achieved, where the first and second common nodes N1 and N2 are arranged as a kind of parallel bus structure with the bus or other pins or terminals located in between the bus structure.

It is noted that the present invention is not restricted to the above preferred embodiments relating to CAN transceivers, but can be applied to any ESD protection circuit arrangement, where input terminals have to be protected. Moreover, any suitable combination of the above preferred embodiments is intended to be covered by the present invention. The preferred embodiments may thus vary within the scope of the appended claims.

1. A circuit arrangement for protecting a connection terminal of a semiconductor device against electrostatic discharge, comprising:
a) a first common node protected against ESD of a first polarity;
b) a second common node protected against ESD of a second polarity opposite to said first polarity;
c) first diode means connected between said connection terminal and said first common node and arranged to couple a charge of said first polarity to said first common node; and
d) second diode means connected between said connection terminal and said second common node and arranged to couple a charge of said second polarity to said second common node.

2. A circuit arrangement according to claim 1, wherein said first and second common nodes are protected by respective first and second ESD protection means.

3. A circuit arrangement according to claim 1, wherein said first and second common nodes are protected by a common ESD protection means, and wherein routing diodes are provided for routing said coupled charges of said first and second diode means through said common ESD protection means.

4. A circuit arrangement according to claim 2, wherein said ESD protection means comprises a Zener diode.

5. A circuit arrangement according to claim 1, further comprising another connection terminal connected via respective third and fourth diode means to said first and second common nodes

6. A circuit arrangement according to claims 1, further comprising another connection terminal connected via respective third and fourth diode means to a respective internal connection of first and second ESD protection means.

7. A circuit arrangement according to claim 6, wherein said first and second ESD protection means each comprise a series connection of Zener diodes, and wherein said internal connection is arranged between two of said Zener diodes of said series connection.

8. A circuit arrangement according to claim 1, wherein said first and second diode means and ESD protection means are monolithically integrated on said semiconductor device.

9. A circuit arrangement according to claim 1, wherein said semiconductor device comprises a transceiver of a controller area network.

10. A method of protecting a connection terminal of a semiconductor device against electrostatic discharge, said method comprising the steps of:
a) providing first and second common nodes;
b) protecting said first and second common nodes against ESD of a first and second polarity, respectively; and
c) coupling said connection terminal via respective first and second diode means to said first and second common nodes.
